(19) United States
(12) Patent Application Publication
(10) Pub. No.: US 2014/0274283 A1
(43) Pub. Date: Sep. 18, 2014

(54) PERSISTENT ASSOCIATION OF GAME FEATURES WITH A USER

(71) Applicant: BIG FISH GAMES, INC., Seattle, WA (US)

(72) Inventors: Seppo Takashi Helava, Oakland, CA (US); Andrew James Vella, Oakland, CA (US); Crystal Elizabeth Silva, Oakland, CA (US); Carey Jean DiJulio, Seattle, WA (US)

(73) Assignee: BIG FISH GAMES, INC., Seattle, WA (US)

(21) Appl. No.: 13/802,212

(22) Filed: Mar. 13, 2013

(51) Int. Cl. G07F 17/32

(52) U.S. Cl. CPC G07F 17/3267
USPC 463/20; 463/43; 463/25

(57) ABSTRACT

The systems and/or processes described herein may unlock, enhance, and/or upgrade one or more features of a game with respect to a user that is playing the game. While the user is playing the game, the systems described herein may monitor a performance or a progression of the user with respect to the game. Upon determining that a predetermined threshold or criteria has been satisfied, such as the user earning a cumulative amount of points or currency, one or more features of the game may be dynamically enhanced or upgraded. Alternatively, or in addition, one or more features of the game may be unlocked to the user, where those features were previously not available to the user. The unlocked, enhanced, and/or upgraded features may be persistently associated with the user such that those features may be available and accessible to the user when the user subsequently plays the game.

### BACKGROUND

With the growing popularity of casual gaming, consumers are able to play various types of games utilizing different mediums, including computing devices, tablet devices, mobile telephones, etc. Individuals may play a particular game independently or with other individuals that are also interested in playing that game. For instance, the individuals may play the game against other individuals or in collaboration with those individuals. Based at least on a performance of an individual that is playing the game, certain features of the game may be unlocked or made available to an individual. Alternatively, other features associated with the game may be upgraded or enhanced. However, when the individual finishes or ceases playing the game, the unlocked, upgraded, and/or enhanced features of the game may no longer be available to that individual. As a result, the individual may not have the opportunity to utilize and enjoy those features when the individual subsequently plays the game at a later time.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example system including one or more users, one or more user devices, one or more networks, and one or more content servers. In this system, unlocked, upgraded, and/or enhanced features of a game may be persistently associated with a user that is playing the game.

FIG. 2 is a flow diagram showing an example process of presenting and persistently displaying an enhancement of a game to a user that is playing the game.

FIG. 3 is a flow diagram showing an example process of persistently associating one or more enhanced, upgraded, and/or unlocked features of a game with a user that is playing the game.

FIG. 4 is a diagram showing an example user interface that displays the enhancement of features of a slot machine game.

### DETAILED DESCRIPTION

This disclosure describes systems and processes for persistently associating one or more enhanced, upgraded, and/or unlocked features of a game with a user that is playing the game. More particularly, as a user is playing a particular game, the progress and/or performance of the user with respect to the game is monitored and optionally displayed to the user. In some embodiments, a graphical user interface associated with the game may indicate criteria or thresholds that the user is to satisfy before various features of the game are unlocked, enhanced, and/or upgraded. For instance, the features may be unlocked, enhanced, and/or upgraded if the user performs a particular action with respect to the game, such as by achieving a certain score, reaching a new level, earning a predetermined amount of currency, beating an opponent, achieving a goal shared by other users, hitting a particular combination of reels, etc. Once the criteria has been satisfied, the features may be dynamically unlocked, enhanced, and/or upgraded, meaning that the newly unlocked, enhanced, and/or upgraded features are presented to the user in real-time.

When earned, the unlocked, enhanced, and/or upgraded features of the game may be persistently associated with the user, meaning that such features may be persistently associated with a profile or an account associated with the user. As a result, the unlocked, enhanced, and/or upgraded features may be accessible to, utilized by, and/or presented to the user when the user subsequently plays the game at a later time. In addition, these features may improve the performance or progression of the user with respect to the game. For instance, having the unlocked, enhanced, and/or upgraded features may help the user compete against, and possibly beat, other opponents who are also playing the same game. In return, the user may receive additional awards (e.g., points, currency, etc.), which may allow the user to unlock additional features of the game, or may which allow the user to upgrade or enhance existing features of the game.

Accordingly, the systems and processes described herein may allow a user to earn new features, or upgrades/enhancements to existing features, associated with a game based at least in part on the user's performance or progression with respect to the game. However, rather than merely allowing the user to utilize those features for a limited period of time, the features are instead persistently associated with that user. As a result, the user may continuously unlock, enhance, and/or upgrade features of the game on an ongoing basis, which may result in a better gaming experience.

The discussion begins with a section, entitled “Example Environment,” describing a system for persistently associating features associated with a game with a particular user. Next, the discussion includes a section, entitled “Example processes,” that illustrates and describes example processes for persistently associating unlocked, upgraded, and/or enhanced features of a game with a particular user. The discussion then moves on to an “Example Enhancement of Game Features” section that describes and illustrates an example embodiment of upgrading and/or enhancing features of a game. Lastly, the discussion includes a brief “Conclusion.”

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Example Environment

FIG. 1 illustrates an architecture 100 in which a user 102 may electronically or physically access games 116 (e.g., software games, casual games, physical games, games played for real or virtual currency, games of chance, etc.) and play those games 116, such as via a user device 104. As described below, the user device 104 may be implemented in any number of ways, such as a computer, a laptop computer, a tablet device, a personal digital assistant (PDA), a multi-functioning communication device, and so on. The user 102 may access the games 116 over a network 106, such as the Internet, which may be communicatively coupled to one or more content server(s) 108. The content server(s) 108 may store various types of games 116, such as software games, and other content that is accessible by the user device 104 (e.g., media content, audio content, video content, etc.). For instance, the user 102 may access and/or play the games 116 via one or more sites (e.g., a website) that are accessible via the network(s) 106 and/or via an application associated with the user device 104. One or more processor(s) 110, a memory 112, and a display 114 of the user device 104 may enable the user 102 to access and/or play the games 116. In addition to the games 116 being stored on, and/or accessed via, the content server(s) 108, the games 116 may also be stored directly on the user device 104.

Furthermore, one or more processor(s) 118 and a memory 120 of the content server(s) 108 may allow the content server(s) 108 to enable the users 102 to play the games 116 and may also allow for various features of the games 116 to be persistently associated with particular users 102 that are playing the games 116. More particularly, a game play module 122, a game progression module 124, a mini game module 126, and a game enhancement module 128 may be stored in memory 120 and executed by the processor(s) 118 to enable the content server(s) 108 to unlock, enhance, and/or upgrade one or more features of the game 116 based on a determined performance or progress of a user 102 with respect to the game 116, and to also persistently associate the unlocked, enhanced, and/or upgraded game features with that user 102. As shown, the mini game module 126 may also maintain, or be associated with, one or more mini games 130.

For the purposes of this discussion, the games 116 may include physical games 116 and games 116 that may be played online or via a user device 104. Moreover, the games 116 may be played for real currency (e.g., U.S. dollars) or virtual currency (e.g., chips, tokens, etc.). The games 116 may also relate to games of chance or casual gaming, which may include physical games, online games that may be played over the network(s) 106, and/or software games that may be stored on, and/or be accessible by, the user device 104.

Games of chance may refer to games in which the outcome is at least partly random or is influenced at least in part by a randomizing device. In games of chance, the players may elect to wager real or virtual currency, or anything of monetary value, prior to at least a portion of the game being played (e.g., spinning a set of reels). Examples of games of chance may include physical games, games played via a network 106, or games played via a user device 104, such as dice games, spinning tops, playing cards, slot machines, roulette wheels, and many other casino games. A game of chance may have some skill element, although the chance or randomness of the game may play a greater role in determining the outcome of the game. In other games of chance, a certain degree of skill may enhance a player's performance with respect to the game. This may be the case where the player(s) make game decisions based upon previous or incomplete knowledge, such as in various casino or card games (e.g., blackjack, poker, etc.).

Casual games 116 may include games 116 (e.g., video games) that are associated with any type of gameplay and any type of genre. Casual games 116 may have a set of simple rules that allow a large audience to play, such games 116 that may be played utilizing a touch-sensitive display, a telephone keypad, a mouse having one or two buttons, etc. Moreover, casual games 116 may not require a long-term commitment or unique skills to play the game 116, thus allowing users 102 to play the game 116 in short time increments, to quickly reach a final stage of the game 116, and/or to continuously play the game 116 without needing to save the game 116. However, users 102 may also save a progress of the game 116 for the purpose of resuming play of the game 116 at a later time. Casual games 116 may also be played on any medium, including personal computers, game consoles, mobile devices, etc., and may be played online via a web browser. Casual games 116 may be referred to as “casual” since the games 116 may be directed towards consumers who can come across the game 116 and get into gameplay in a short amount of time, if not immediately. Examples of casual games 116 may include puzzle games, hidden object games, adventure games, strategy games, arcade and action games, word and trivia games, casino games, card and board games, and many others.

Other games 116 may first be downloaded to and/or installed on the user device 104 and/or an application associated with the user device 104. These games 116, and the physical games, the games of chance (including physical and virtual games), and the casual games 116 described above, may also be acquired by the user 102. Regardless of whether the games 116 are stored on the user device 104 or the content server(s) 108, playing the games 116 may include accessing, viewing, trying, and/or otherwise interacting with the games 116.

The users 102 may access the games 116 in any of a number of different manners. For instance, the users 102 may play the games 116 in a physical setting (e.g., physical slot machines). The users 102 may also access a site (e.g., a website) associated with an entity, such as a merchant, that provides access to the games 116. Such a site may be remote from the user device 104 but may allow the users 102 to interact with the games 116 via the network(s) 106. Moreover, the users 102 may download one or more applications to the user device 104 in order to access the games 116. In this case, the content server(s) 108 may provide, transmit, suggest, and/or recommend the games 116 to the user device 104, whereby the users 102 may interact with the games 116 via the downloaded application(s). In other embodiments, the games 116 may be streamed from the content server(s) 108 to the user device 104 such that the users 102 may interact with the games 116 in real-time. Once the user 102 accesses the games 116, the users 102 may perform a variety of actions, including learning about the games 116, viewing the games 116, trying the games 116, acquiring (e.g., purchasing, renting, leasing, etc.) the games 116, downloading/installing the games 116 to the user device 104, and/or playing the games 116.

Additionally, the users 102 may have a user account associated with the entity that provides and/or provides access to the games 116. For instance, assuming that the games 116 are available via a website, each of the users 102 may have a user account that specifies various types of information relating to the users 102. This information may include personal information, user preferences, and/or some user identifier (ID), which may be some combination of characters (e.g., name, number, etc.) that uniquely identifies the user 102 from other users 102.

In some embodiments, the user device 104 may be any type of device that is capable of receiving, accessing, playing, and/or otherwise interacting with the games 116, such as, for example, a personal computer, a laptop computer, a cellular telephone, a personal digital assistant (PDA), a tablet device, an electronic book (e-Book) reader device, a television, or any other device that may be used to access games 116 that may be viewed, tried, played, downloaded, installed, and/or acquired by the user 102. For instance, the user 102 may utilize the user device 104 to access and navigate between one or more sites, such as web sites, web pages related thereto, and/or documents or content associated with those websites or web pages that may be of interest to the user 102. For instance, the user 102 may utilize the user device 104 to access sites to view, play, and/or download the games 116. Further, the user device 104 shown in FIG. 1 is only one example of a user device 104 and is not intended to suggest any limitation as to the scope of use or functionality of any user device 104 utilized to perform the processes and/or procedures described herein. Although the games 116 may be played via the user device 104, certain games 116 may be played without the use of a user device 104. For example, various physical games and/or games of chance (e.g., slot machines, table top games, etc.) may be played in a physical setting without use of such user devices 104.

The processor(s) 110 of the user device 104 may execute one or more modules and/or processes to cause the user device 104 to perform a variety of functions, as set forth above and explained in further detail in the following disclosure. In some embodiments, the processor(s) 110 may include a central processing unit (CPU), a graphics processing unit (GPU), both CPU and GPU, or other processing units or components known in the art. For instance, the processor(s) 110 may allow the user device 104 to access sites associated with the games 116 and/or download applications that are used to access and/or play the games 116. Additionally, each of the processor(s) 110 may possess its own local memory, which also may store program modules, program data, and/or one or more operating systems.

In at least one configuration, the memory 112 of the user device 104 may include any component that may be used to access, play, and/or download the games 116. Depending on the exact configuration and type of the user device 104, the memory 112 may also include volatile memory (such as RAM), non-volatile memory (such as ROM, flash memory, miniature hard drive, memory card, or the like) or some combination thereof.

In various embodiments, the user device 104 may also have input device(s) such as a keyboard, a mouse, a pen, a voice input device, a touch input device, etc. The user device 104 may also include the display 114 and other output device(s), such as speakers, a printer, etc. The user 102 may utilize the foregoing features to interact with the user device 104 and/or the content server(s) 108 via the network(s) 106. More particularly, the display 114 of the user device 104 may include any type of display known in the art that is configured to present (e.g., display) information to the user 102. For instance, the display 114 may be a screen or user interface that allows the user 102 to access, play, and/or download the games 116. Further, one or more local program modules may be utilized to play the games 116 on a browser. The local program modules may be stored in the memory 112 and/or executed on the processor(s) 110 in order to present graphics associated with the games 116 on the display 114.

In some embodiments, the network(s) 106 may be any type of network known in the art, such as the Internet. Moreover, the user device 104 and the content server(s) 108 may communicatively couple to the network(s) 106 in any manner, such as by a wired or wireless connection. The network(s) 106 may also facilitate communication between the user device 104 and the content server(s) 108, and also may allow for the transfer of data or communications therebetween. For instance, the content server(s) 108 and/or other entities may provide access to the games 116 that may be accessed, played, and/or downloaded utilizing the user device 104.

In addition, and as mentioned previously, the content server(s) 108 may include one or more processor(s) 118 and a memory 120, which may include the game play module 122, the game progression module 124, the mini game module 126, and the game enhancement module 128. The content server(s) 108 may also include additional components not listed above that perform any function associated with the content server(s) 108. In various embodiments, the content server(s) 108 may be any type of server, such as a network-accessible server, or the content server(s) 108 may be any entity that provides access to the games 116 that is stored on and/or is accessible by the content server(s) 108.

In various embodiments, the game play module 122 may enable users 102 to play one or more of the games 116. In particular, the game play module 122 may allow a single user 102 to play one of the games 116 in a physical setting or a virtual environment. Alternatively, multiple users 102 may play one of the games 116 in the virtual environment. In some embodiments, users 102 may independently play a single player game 116 in the virtual environment, where each user 102 is represented within the virtual environment by text, an image, an avatar, and/or other identifying information. During play of the game 116, each user 102 may progress towards a certain goal, such as an amount of points, an amount of currency (e.g., awards, trophies, dollars, chips, prizes, etc.), and/or reaching or passing levels associated with the game 116.

Moreover, the game progression module 124 may determine a progression and/or a performance of a particular user 102 while that user 102 is playing the game 116. In various embodiments, the game progression module 124 may indicate to the user 102 a performance of the user 102 with respect to the game 116 (e.g., a progress bar), which may include a cumulative amount of points or currency, a progression through the game 116, etc. The game progression module 124 may also indicate certain goals or thresholds that the user 102 is to satisfy or exceed in order to unlock, upgrade, and/or enhance various features associated with the game 116. The goals or thresholds may also correspond to the triggering of mini games 130 for that particular user 102.

The mini game module 126 may trigger one or more mini games 130 while a user 102 is currently playing a particular game 116. The mini games 130 may be triggered based at least in part on predetermined criteria associated with the game 116, which may correspond to events associated with the game 116 that may occur or that may be caused by actions of the user 102 that is currently playing the game 116. For instance, the predetermined criteria may correspond to the user 102 achieving a certain score, gaining a particular amount of currency (e.g., points, dollars, trophies, chips, awards, etc.), receiving one or more particular cards, and/or hitting a particular set of reels in a slot machine game 116 context. The mini game module 126 may monitor the status of each user 102 that is playing the game 116, as well as the progress of each user 102 with respect to the game 116. As a result, the mini game module 126 may determine when one of the criteria has been satisfied (e.g., when one of the events that is associated with the game 116 has occurred).

In response to determining that one or more of the predetermined criteria has been satisfied, the mini game module 126 may trigger the presentation of a mini game 130. The mini game 130 may be collaborative or competitive in nature, such that the user 102 may play with other users 102 for the purpose of achieving a shared goal, or the user 102 may compete against (e.g., play against) one or more other users 102. Furthermore, when triggered, the mini game 130 may be presented to the user 102 within the virtual environment and the progression, performance, or status of the user 102 that is playing the mini game 130 may also be displayed in real-time. The mini game 130 may correspond to any type of game that allows the user 102 to participate in a collaborative or competitive manner, such as a race or a head-to-head cooking competition, for instance. Moreover, the winner of the mini game 130 may receive some award or benefit, such as an amount of points or currency, an enhanced, upgraded, or unlocked feature of the game 116, and so forth.

The game enhancement module 128 may unlock, enhance, and/or upgrade one or more features associated with the game 116 with respect to the user 102. In some embodiments, the features may be unlocked, enhanced, and/or upgraded based at least in part on the user's 102 progression and/or performance with respect to the game 116. For example, in response to the user 102 achieving a predetermined amount of points or currency, passing a level of the game 116, beating an opponent, participating in a certain number of mini games 130, etc., the unlocked, enhanced, and/or upgraded features may be presented to the user 102. In addition, these features may be persistently associated with the user 102 such that the user 102 may continuously earn and also maintain the unlocked, enhanced, and/or upgraded features on an ongoing basis. As a result, the unlocked, enhanced, and/or upgraded features of the game 116 may be still be associated with the user 102 when the user 102 plays the game 116 at a later time. Maintaining the features that have previously been earned may result in a more positive and enjoyable gaming experience.

### Example Processes

FIGS. 2 and 3 describe various example processes of persistently associating one or more features of a game with a user that is playing the game. The example processes are described in the context of the environment of FIG. 1 but are not limited to those environments. The order in which the operations are described in each example method is not intended to be construed as a limitation, and any number of the described blocks can be combined in any order and/or in parallel to implement each method. Moreover, the blocks in FIGS. 2 and 3 may be operations that can be implemented in hardware, software, or a combination thereof. In the context of software, the blocks represent computer-executable instructions stored in one or more computer-readable storage media that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 2 is a flow diagram illustrating an example process 200 of associating an enhancement associated with a game with a user that is currently playing the game. Moreover, the following actions described with respect to FIG. 2 may be performed by a server, a service provider, a merchant, and/or the content server(s) 108, as shown in FIG. 1

Block 202 illustrates enabling a user to play a game. More particularly, the content server(s) 108 may allow one or more users 102 to play a particular game 116, such as playing the game 116 via a corresponding user device 104 and/or via the network(s) 106. The game 116 may correspond to a single player game 116 where the user 102 plays the game 116 independently from other users 102 or a multi-player game 116 where multiple users 102 play the game 116 in competition with, or in collaboration with, other players. The game 116 may also be played within a virtual environment that is accessible via user device 104. During the game 116, the user 102 may receive points, currency (e.g., coins, tokens, dollars, chips, etc.), and/or other value that is based on the user's 102 performance or progression with respect to the game 116. As stated above, the game 116 may be a physical game played in a physical setting, games of chance (including both physical games and virtual games), casual games, games played for real currency or virtual currency, or any other type of game 116.

Block 204 illustrates presenting a mini game to the user when a criteria associated with the game is satisfied. In various embodiments, the criteria may relate to the user 102 achieving a certain score, obtaining a particular amount of points or currency, receiving a specific card or set of cards, hitting a particular set of reels, passing a level of the game 116, and so on. Therefore, the criteria may correspond to events associated with the game 116 that may occur during game play, in which the events may occur in response to the user 102 performing a particular action (e.g., pressing a button, playing a card, beating an opponent, reaching a goal, spinning reels, etc.) with respect to the game 116. By monitoring each of the users 102 as they are playing the game 116, the content server(s) 108 may determine when one of the criteria has been satisfied.

The mini game 130 may refer to a collaborative and/or competitive game that may involve any number of users 102 that were currently playing the game 116 when the mini game 130 was triggered. For instance, while the user 102 is playing the mini game 130, the user 102 may collaborate with other users 102 in an attempt to achieve a shared goal, or the user 102 may compete against one or more other users 102. Moreover, the mini game 130 may relate to any type or theme (e.g., a chef competition, a sheriff vs. bandits, people vs. zombies, police vs. criminals, etc.) and may refer to any game that illustrates the real-time progression or performance of the participating users 102 during the mini game 130. For instance, the progression of the users 102 may be shown as the users 102 racing around a track, filling up some object (e.g., a balloon, a bucket, etc.), a progress bar, weights on a scale, and so forth. In some embodiments, each user 102 may be represented by a symbol, an image, text, a color, etc., that uniquely identifies each user 102 and shows the progression or performance of each player with respect to the mini game 130. As a result, each user 102 may determine their performance in relation to the performance of other users 102 that are participating in the mini game 130. The mini game 130 may also be presented to the user 102 in any manner, such as via a pop-up window, within the virtual environment, within a different virtual environment, adjacent to the game 116, via a window overlaid on the game 116, via a separate page or screen, and so forth.

Block 206 illustrates providing an award to the user based on a result of the mini game. More particularly, the award may correspond to points or currency that are awarded to the user. In some embodiments, provided that the user 102 is competing against a different user 102 during the mini game 130, the outcome of the mini game 130 may depend upon the performance or progression of the users 102 with respect to the game 116. That is, a user 102 having a higher cumulative point or currency total, a user 102 that has unlocked more game features, or a user 102 that has earned more enhanced or upgraded game features may have a higher likelihood of winning the mini game 130. For instance, if the mini game 130 involves two chefs competing against one another, the user 102 that has upgraded equipment (e.g., knives, etc.), more/better ingredients, a more visually appealing chef uniform, a higher chef rating, etc., may be more likely to win the competition.

In some embodiments, one or more winners of the mini game 130 may be determined if at least one user 102 achieves a certain goal (e.g., crossing the finish line, accumulating a certain amount of points/currency, etc.). In other embodiments, one or more winners may be determined after a predetermined amount of time after the mini game 130 has begun. That is, the user(s) 102 that are currently winning the mini game 130 (e.g., highest amount of points/currency) when the predetermined amount of time expires may be declared the winner(s). In response to the winner(s) of the mini game 130 being determined, the winner(s) may be displayed within the virtual environment to the other users 102.

Moreover, in response to determining one or more winners of the mini game 130, a particular benefit, such as a prize, an award, an amount of points or currency (e.g., dollars, coins, chips, etc.), etc., may be awarded to that user 102 (or multiple users 102). Similar benefits may also be awarded to other users 102 that participated in the mini game 130 (e.g., a second place user 102, a third place user 102, etc.). Moreover, benefits may be awarded to each user 102 that participated in the mini game 130, where the amount of benefits that are awarded may depend upon the performance of each user 102. Regardless of which users 102 receive benefits, such benefits may be added to a cumulative point or currency total that is associated with the game 116 that was being played prior to the mini game 130 being triggered. As discussed in further detail below, a user 102 winning the mini game 130 may cause one or more features of the game 116 to become unlocked with respect to that user 102. In addition, one of more game features associated with that user 102 may be enhanced and/or upgraded in response to that user 102 winning the mini game 130.

Block 208 illustrates determining a progress or a performance of the user with respect to the game. More particularly, the content server(s) 108 may determine how the user 102 is performing and/or how the user 102 is progressing through the game 116 while the user 102 is actually playing the game 116. The progress and/or performance of the user 102 may be presented in any manner, such as via a progress bar. In addition, the content server(s) 108 my display one or more goals or thresholds that may be achieved by the user 102, where the goals or thresholds may relate to a cumulative amount of points or currency that is to be gained by the user 102, a number of games 116 or mini games 130 participated in or won by the user 102, etc. As a result, the user 102 may be aware of actions that are to be performed in order for the user 102 to unlock features associated with the game 116 or to cause existing features of the game 116 to be upgraded and/or enhanced.

Block 210 illustrates determining that the progress or the performance of the user has exceeded a predetermined threshold. As stated above, the content server(s) 108 may indicate to the user 102 various predetermined thresholds that may relate to a performance or progress of the user 102 with respect to the game 116. A particular predetermined threshold may correspond to a cumulative amount of currency or points that is to be achieved by the user 102, a level that is to be reached, a particular combination of reels that is to be hit, a number of mini games 130 to be played or won, and so on. As the user 102 plays the game 116, the user 102 may progress towards and exceed at least one of the predetermined thresholds, such as the user 102 earning an amount of points or currency that exceeds an amount of points or currency, respectively, that corresponds to the predetermined threshold. In some embodiments, the user 102 may exceed the predetermined thresholds by participating in, and possibly winning, a certain number of mini games 130 associated with the game 116.

Block 212 illustrates dynamically presenting an enhancement to the game with respect to the user. In response to the user 102 exceeding the predetermined threshold, one or more features of the game 116 may be unlocked, enhanced, and/or upgraded with respect to the user 102. For instance, a particular feature of the game 116 that was previously unavailable to the user 102 may now become available to the user 102. In some embodiments, the newly unlocked features may allow the user 102 to perform at a higher level with respect to the game 116 (e.g., earn additional points or currency, increase likelihood of beating an opponent, etc.). Moreover, the visual appearance, functionality, etc., of a feature that was available to the user 102 may be enhanced and/or upgraded. For example, the visual appearance of an image associated with a feature may be enhanced and/or upgraded, such as by changing a color or brightness of the image, increasing the resolution of the image, making the image more decorative or detailed, etc. In addition, the items included in the image may also be enhanced and/or upgraded (e.g., increasing the number of items, replacing previous items with better items, etc.). In various embodiments, the enhancement of the features of the game 116 may be specifically associated with that user 102, meaning that the enhancement may not be experienced by other users 102 that are playing the game 116.

Block 214 illustrates persistently associating the enhancement to the game with the user. In response to unlocking, enhancing, and/or upgrading features associated with the game 116, such features may be persistently associated with the user 102, meaning that the features may be maintained by the user 102 while the user 102 is playing that particular game 116. Therefore, the user 102 may continuously obtain additional unlocked, upgraded, and/or enhanced features of the game 116 on an ongoing basis and that are specifically tied to a profile, account, character, avatar, etc., corresponding to that user 102. As the user 102 continues to play the game 116 the amount of unlocked, upgraded, and/or enhanced game features may become more robust and may allow the user 102 to play the game 116 at a relatively higher level. In addition, provided that the user 102 ends a session associated with the game 116, the unlocked, enhanced, and/or upgraded features may be available to the user 102 when the user 102 begins a subsequent, different session of the game 116.

In other embodiments, the unlocked, enhanced, and/or upgraded features associated with the game 116 and that are earned or obtained by the user 102 may not be persistent with respect to different sessions of the game 116. For instance, assume that the user 102 is playing the game 116 during a first session, and that the user 102 has earned unlocked, enhanced, and/or upgraded features that are associated with the game 116. Those features may influence play of the game 116 with respect to that user 102. For instance, the unlocked, enhanced, and/or upgraded features may cause the user 102 to have an increased likelihood of winning the game 116, of triggering or winning mini games 130, or may help improve the overall performance of the user 102 with respect to the game 116 and/or associated mini games 130. However, in some circumstances, such features may be available to the user 102 only during the particular session in which the features are earned. That is, if the user 102 ends the first session and then later begins a new, second session, the unlocked, enhanced, and/or upgraded features may no longer be available to the user 102, even if the user 102 is playing the same game 116 that was being played during the first session. Accordingly, although the unlocked, enhanced, and/or upgraded features may be persistently associated with the user 102 during a particular session, those features may not be persistently associated with the user 102 from session to session.

In various embodiments, the unlocked, enhanced, and/or upgraded features of the game 116 may have an effect on a goal or desired outcome that is shared by multiple players that are playing the game 116. More particularly, as the players of the game 116 earn the unlocked, enhanced, and/or upgraded features, those unlocked, enhanced, and/or upgraded features may cause the players to have an increased likelihood of meeting the common goal or desired outcome. Provided that the common goal is reached, each of the game players, or only those players that participated in satisfying the common goal, may receive an award or benefit, where the award or benefit may be specific to individual users 102 or may be a game upgrade that is shared by the community of users 102.

For instance, assume that the game 116 is a slot machine game in which the players of the game 116 are attempting to hit certain combination of reels of the slot machines. In some embodiments, the slot machine game 116 may be a volcano slot machine game where the users 102 that are playing the game 116 (e.g., the users 102 sitting at the table) may feed the volcano in a collaborative manner. As the players progress through the slot machine game 116, the reels associated with the slot machines (e.g., the images on the reels) may be enhanced or upgraded. That is, the players of the volcano slot machine game 116 may receive unlocked, enhanced, and/or upgraded features (e.g., unlocked, enhanced, and/or upgraded reels) that could be used to feed the volcano and, therefore, satisfy a community goal (e.g., cause the volcano to erupt). By feeding the unlocked, enhanced, and/or upgraded features to the volcano, the users 102 may be increasing the likelihood that the community goal or the desired outcome of the game 116 is satisfied.

In other embodiments, the unlocked, enhanced, and/or upgraded features obtained by individual players may have a community benefit or effect, meaning that unlocked, enhanced, and/or upgraded features earned by one player may benefit other players of the game 116. For instance, assume that the users 102 are playing a slot machine game 116 where the community goal is to destroy a castle or to beat/conquer an enemy. Accordingly, the reels may determine the amount of damage that each user 102 is able to administer. For instance, as users 102 obtain upgraded and/or enhanced reels, those users 102 may be capable of inflicting a greater amount of damage to the enemy or the castle. Therefore, an increase in the number of unlocked, enhanced, and/or upgraded reels for the users 102 that are playing the game 116 may cause a shared change in the game 116 and a benefit for each of those users 102 (e.g., storming or damaging the castle, overcoming the enemy, etc.). As a result, the unlocked, upgraded, and/or enhanced features allow the users 102 to play the slot machine game 116 in a collaborative manner.

FIG. 3 is a flow diagram illustrating an example process 300 of providing, to a user, unlocked, enhanced, and/or upgraded features of a game that are persistently associated with the user. Moreover, the following actions described with respect to FIG. 3 may be performed by a server, a service provider, a merchant, and/or the content server(s) 108, as shown in FIG. 1

Block 302 illustrates monitoring a progression or a performance of a user playing a game. In various embodiments, the content server(s) 108 may monitor and/or determine a progress or performance of a user 102 with respect to a game 116 while the user 102 is playing the game 116. In addition to monitoring the performance/progression of the user 102, the content server(s) 108 may also display this information to the user 102, such as in a progress bar. The progress bar, or any other mechanism that illustrates the performance/progression of the user 102, may display a cumulative amount of currency or points earned, a number of mini games 130 in which the user 102 has participated in and/or won, or any other type of information.

In an illustrative embodiment, the game 116 may be a physical or virtual slot machine game 116 that is played by the user 102. For the purposes of this discussion, a slot machine game 116 may correspond to a game 116 where multiple reels (e.g., three reels) may be spun in response to a user actuation (e.g., pushing a button, making contact with a touch-sensitive display, etc.) from one of the users 102. The users 102 may place a bet (e.g., points, currency, coins, chips, etc.) and then actuate a lever in order to cause the one or more reels to spin. Each of the reels may include symbols or images that correspond to symbols and images on the other reels. When the reels are spun and then stop spinning, the symbols or images on the reels may be visible to the users 102. The slot machine game 116 may pay out points, currency, coins, chips, etc., based at least in part on the multiple reels having matching symbols/images or specific patterns or combinations of symbols/images.

In response to the users 102 betting currency (e.g., points, coins, chips, etc.) and playing the game 116 (e.g., spinning the reels), the users 102 may win one or more jackpots if the reels display predetermined patterns or combinations of symbols/images. Alternatively, if such patterns or combinations do not appear after the reels stop spinning, the users 102 may bet additional currency to further play the game 116. As a result, since the users 102 may bet currency to play, and possibly be awarded currency upon hitting a particular combination of symbols/images on the reels, an cumulative amount of points or currency associated with each user 102 may fluctuate upwards or downwards during play of the game 116. Therefore, in the slot machine game 116 context, the performance or progression of the user 102 may correspond to the cumulative total of points or currency won as a result of spinning the reels and hitting various combinations of the symbols/images displayed on the reels.

Block 304 illustrates awarding currency to the user based on the progression or the performance. In various embodiments, as the user 102 plays the game 116, the user 102 may be awarded points, currency, etc., which may then be added to a cumulative amount of points, currency, etc., that is associated with the user 102. For instance, while the user 102 is playing the slot machine game 116, the user 102 may actuate the lever to spin the reels, which may result in the user 102 hitting various combinations of images on the reels that causes the user 102 to win points, currency, etc. The amount of points, currency, etc., won may be added to a running total of points, currency, etc., that is maintained for the user 102 and that specifically relates to the slot machine game 116. In other embodiments, the running total may also correspond to other games 116 that are played by the user 102.

Moreover, in response to satisfying criteria associated with the game 116, a mini game 130 may be triggered and presented to the user 102. Such criteria may correspond to a predetermined event that may occur during play of the game 116. For instance, the criteria may relate to the user 102 reaching a certain amount of points or currency. Here, the criteria may correspond to the user 102 hitting a particular combination of symbols/images that are displayed on the reels, which may be displayed in response to the user 102 spinning the reels. For instance, the criteria may be satisfied when the user 102 hits the same symbol/image on each one of the multiple reels. In addition to the criteria being satisfied, the user 102 may receive an award of points, currency, etc. (e.g., a jackpot).

Upon the mini game 130 being triggered, the user 102 may cause the reels of the slot machine game 116 to spin in order to win the most currency (e.g., money, points, chips, etc.) or to compete against another user 102. That is, the mini game 130 may correspond to a head-to-head game between the user 102 and a different user 102. For example, the users 102 may each be represented by a chef that is attempting to cook a dish or meal in the most rapid manner. To accomplish this, the user 102 may pull the lever to spin the reels of the slot machine game 116, which may cause points or currency to be awarded to the user 102. The points or currency may then be added to the cumulative points/currency total, which may be represented to the user 102 in the progress bar. Although the mini game 130 is being described in the slot machine game 116 context, it is contemplated that any type or theme of game 116 may be utilized.

In certain embodiments, the winner of the mini game 130 may be presented with a graphic, possibly within a pop-up window, that displays a “victory” screen. On the other hand, users 102 that did not win the mini game 130 may be presented with a “lose” screen, which may illustrate how close those users 102 were to winning the mini game 130.

Block 306 illustrates determining that the progression or the performance of the user exceeds a predetermined threshold. As set forth above, the content server(s) 108 may establish one or more thresholds that represent an amount of points, currency, mini games 130 won, etc., in order to cause one or more features of the game 116 to be unlocked, enhanced, and/or upgraded with respect to the user 102. In the slot machine game 116 context, the predetermined threshold may corresponds to a total amount of points or currency that is to be won by the user 102 while playing the slot machine game 116. As the user 102 wins points, currency, etc., those points/currency may be added to cumulative total associated with the user 102, which may allow the user 102 to meet or exceed the predetermined threshold. For example, a status bar that is displayed to the user 102 may be partially or fully filled, which may represent whether or not the user 102 has exceeded the predetermined threshold.

Block 308 illustrates dynamically enhancing or upgrading one or more features of the game with respect to the user. More particularly, in response to the user 102 exceeding the predetermined threshold (e.g., exceeding the predetermined point or currency total), the content server(s) 108 may enhance or upgrade one or more features of the game 116 in real-time, where the enhanced or upgraded features may be specifically associated with that user 102, and possibly only that user 102. The enhancement or upgrading of the features may entail any change to a feature of the game 116 that creates a more positive or enjoyable gaming experience. For instance, the enhancement or upgrading of features may be associated with the aesthetics (e.g., the visual aspects) of the game 116 (e.g., color, brightness, additional decoration or detail, etc.), the improvement of equipment used to play the game 116, the addition of items that were previously accessible to the user 102, etc. In addition, enhancing or upgrading the features may allow the user 102 to play the game 116 at a higher performance level, and may assist the user 102 in playing the mini games 130, thus possibly giving the user 102 an advantage in winning the mini games 130.

With respect to a slot machine game 116, each of the reels may contain multiple different images, where the user 102 that is playing the game 116 may receive an award (e.g., points, currency, etc.) when the user 102 hits a particular combination of images. In some embodiments, the slot machine game 116 may have a chef/restaurant theme such that the images on the reels may correspond to ingredients, food, cooking equipment/tools, etc. Upon the predetermined threshold being exceeded, one or more of the images on the reels may be dynamically enhanced and/or upgraded. For instance, an image of a butter knife may be upgraded to an image of a cleaver, an image of a hot dog may be upgraded to an image of a steak, or an image of a particular ingredient (e.g., frozen carrots) may be upgraded to an image of a higher quality ingredient (e.g., fresh carrots). Moreover, the image on the reels may remain the same, but the visual representation of the image may be enhanced or upgraded. For example, an image may become more colorful, the image may become brighter, the resolution of the image may be increased, the item(s) included in the image may be enhanced to have additional detail or decoration, etc.

As a result, as the user 102 plays the game 116, the features of the game 116 (e.g., the images on the reels) may be upgraded/enhanced on an ongoing basis in real-time. The images may continue to be dynamically upgraded or enhanced over time based on the performance of the user 102 with respect to the game 116. For example, an image of a butter knife may be upgraded to an image of a paring knife, which may then be upgraded to an image of a cleaver. The upgraded features (e.g., images on the reels) may cause the user 102 to have a higher likelihood to beat opponents during mini games 130 associated with the game 116.

Block 310 illustrates dynamically unlocking one or more features of the game with respect to the user. Alternatively, or in addition to dynamically enhancing one or more features of the game 116, the content server(s) 108 may dynamically unlock one or more features of the game 116 in response to determining that the predetermined threshold has been satisfied. That is, the content server(s) 108 may make available one or more features of the game 116 that were not previously available to the user 102. Such unlocked features may allow the user 102 to play the game 116 at a higher performance level and may increase the likelihood that the user 102 will prevail in subsequent mini games 130. In the context of a chef/restaurant game 116, the unlocked features may correspond to additional ingredients, additional cooking gear/equipment (e.g., knives, pots, utensils, etc.), etc. Therefore, as the user 102 continues to play the game 116 and earns points, currency, etc., based on the user's 102 performance/progression associated with the game 116, the user 102 may continue to unlock and have access to additional features associated with the game 116.

Block 312 illustrates providing an additional award to the user. Moreover, the user 102 may also receive additional benefits in response to the predetermined threshold being satisfied. For instance, the user 102 may receive points, currency, etc., that may be added to a cumulative points/currency total associated with the user 102, provided that the user 102 caused the predetermined threshold to be satisfied.

Block 314 illustrates persistently associating the enhanced, upgraded and/or unlocked features with the user. In various embodiments, as the features associated with the game 116 are enhanced, upgraded, and/or unlocked with respect to the user 102, those enhanced, upgraded, and/or unlocked features may be persistently associated with the user 102. As a result, such features are saved on an ongoing basis such that the user 102 maintains the previously earned enhanced, upgraded, and/or unlocked features. In some embodiments, the enhanced, upgraded, and/or unlocked features are persistently attached to an account, a character, a profile, etc., associated with the user 102 such that these features may be accessible to the user 102 when the game 116 is played at a later time. In other embodiments, and as stated above with respect to FIG. 2, the enhanced, upgraded, and/or unlocked features may be persistently associated with the user 102 during a particular session in which those features are earned, but that the features may no longer be available in a subsequent session. Therefore, as the user 102 continues to play the game 116, the amount of features that have been unlocked or enhanced/upgraded will continue to increase over time, which may result in a more positive and enjoyable gaming experience.

### Example Enhancement of Game Features

FIG. 4 illustrates an example diagram 400 that shows how the features of a game may be dynamically unlocked, enhanced, and/or upgraded over time. In various embodiments, the diagram 400 may represent a slot machine game 402 that includes multiple reels (reels 404-408). The slot machine game 402 may be a physical slot machine game 402 played in a physical setting or a virtual slot machine game 402 played within a virtual environment or played via an application associated with a user device 104. Although three reels 404-408 are illustrated in FIG. 4, any number of reels 404-408 may be associated with the slot machine game 402. As shown, the diagram 400 shows the slot machine game 402 at a first time 410 and the slot machine game 402 at a second time 412 that is subsequent in time to the first time 410. As is described below, the images associated with reels 404-408 at the first time 410 may be dynamically enhanced or upgraded. The enhanced/upgraded images are shown in reels 404-408 at the second time 412.

In particular, at the first time 410, reel 404 is associated with an image of a butter knife, reel 406 is associated with an image of a hot dog, and reel 408 is associated with an image of an egg. Based at least in part on the performance of the user 102 with respect to the game 402 (e.g., the user 102 earning points/currency, a predetermined threshold being satisfied, the user 102 hitting a predetermined combination of reels, etc.), the images associated with reels 404-408 may be dynamically upgraded and/or enhanced. For instance, as shown at the second time 412, the image of the butter knife shown in reel 404 has been enhanced to an image of a chef's knife. Moreover, the image of the hot dog shown in reel 406 has been enhanced to an image of a steak. Lastly, the image of the egg, as shown in reel 408, has been enhanced to an image of a carton of multiple eggs.

Therefore, the features (e.g., images) associated with the game 116 (e.g., the slot machine game 402) may be dynamically unlocked, enhanced, and/or upgraded on an ongoing basis as a user 102 plays the game 116. In addition, the unlocked, enhanced, and/or upgraded features may be persistently associated with the user 102 such that those features remain with the user 102 throughout play of the game 116.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A system comprising:
memory;
one or more processors;
a game play module stored in the memory and executable by the one or more processors to enable a user to play a game, the game being a game of chance;
a game progression module stored in the memory and executable by the one or more processors to determine a performance or a progression of the user with respect to the game; and
a game enhancement module stored in the memory and executable by the one or more processors to:
dynamically provide an enhancement to the game with respect to the user and based at least in part on the performance or the progression of the user; and
persistently associate the enhancement to the game with the user.

2. The system as recited in claim 1, further comprising a mini game module stored in the memory and executable by the one or more processors to present a mini game to the user based at least in part on the performance or the progression of the user.

3. The system as recited in claim 2, wherein the mini game module is further executable by the one or more processors to:
facilitate a competition between a user and a different user during the mini game;
provide an award to the user based at least in part on a result of the mini game; and
add the award to a cumulative award total associated with the user.

4. The system as recited in claim 1, wherein the game is a slot machine game, and further comprising a mini game module stored in the memory and executable by the one or more processors to trigger a mini game in response to determining that the user has hit a predetermined combination of images associated with reels of the slot machine game.

5. The system as recited in claim 1, wherein the enhancement to the game includes enhancing or upgrading one or more features associated with the game with respect to the user or with respect to a community of users that are collaboratively playing the game.

6. The system as recited in claim 1, wherein the enhancement to the game includes unlocking one or more features of the game that were not previously available to the user.

7. The system as recited in claim 1, wherein:
the game is a slot machine game; and
the enhancement to the game is at least one of enhancing or upgrading an image associated with a reel of the slot machine game or unlocking a feature associated with the slot machine game.

8. The system as recited in claim 1, wherein the enhancement to the game includes upgrading, enhancing, or unlocking a feature associated with the game, the enhancement to the game relating to at least one of a visual appearance of the feature, an availability of the feature to the user, a replacement of the feature, a modification of the feature, or an addition of items associated with the feature.

9. The system as recited in claim 1, wherein the game enhancement module is further executable by the one or more processors to provide an award to the user based at least in part on the performance or the progression of the user, the award being added to a cumulative award total associated with the user.

10. One or more computer-readable media having computer-executable instructions that, when executed by one or more processors, perform operations comprising:
monitoring a performance or a progression of a user with respect to a game, the game being a game of chance that is played in a physical setting, in a virtual environment via a network, or via an application associated with a user device;
determining that the performance or the progression of the user exceeds a predetermined threshold;
dynamically enhancing, upgrading, or unlocking a feature associated with the game in response to determining that the performance or the progression of the user exceeds the predetermined threshold; and
persistently associating the enhanced, upgraded, or unlocked feature with the user.

11. The computer-readable media as recited in claim 10, wherein the predetermined threshold corresponds to a cumulative amount of points or currency associated with the user.

12. The computer-readable media as recited in claim 10, wherein the game is a slot machine game, and wherein the feature is at least one image displayed on one or more reels associated with the slot machine game.

13. The computer-readable media as recited in claim 10, wherein the enhanced, upgraded, or unlocked feature is at least one of:
displayed to the user when the user plays the game at a subsequent time; or
persistently associated with the user during a first session in which the enhanced, upgraded, or unlocked feature is obtained, but is no longer available during a subsequent second session.

14. The computer-readable media as recited in claim 10, wherein the enhanced, upgraded, or unlocked feature increases a likelihood that the user will win the game or a competitive or collaborative mini game that is triggered during the game.

15. The computer-readable media as recited in claim 10, wherein the performance or the progression of the user is displayed to the user while the user is playing the game.

16. A method comprising:
determining that a criteria associated with a game has been satisfied, the game being a slot machine game played in a physical setting, in a virtual environment via a network, or via an application associated with a user device, and the criteria being satisfied in response to a user playing the game;
dynamically enhancing, upgrading, or unlocking a feature of the game based at least in part on the criteria being satisfied; and
associating the enhanced, upgraded, or unlocked feature with the user.

17. The method as recited in claim 16, wherein the enhanced, upgraded, or unlocked feature is persistently associated with a character, a profile, an account, or other identifying information associated with the user.

18. The method as recited in claim 16, wherein the criteria corresponds to at least one of a cumulative points or currency total associated with the user, a particular action taken by the user while playing the game, or a predetermined result associated with the game.

19. The method as recited in claim 16, wherein the criteria corresponds to at least one of the user earning a cumulative amount of points or currency or the user hitting a particular combination of images associated with reels of the slot machine game.

20. The method as recited in claim 16, further comprising:
triggering a mini game that is presented to the user and that is associated with the game based at least in part on the criteria being satisfied; and
providing an award to the user based at least in part on a result of the mini game.
